(19) United States
(12) Patent Application Publication
(10) Pub. No.: US 2005/0202786 A1
(43) Pub. Date: Sep. 15, 2005

(54) Network supervisory control system and network supervisory control method

(75) Inventor: Yosuke Ishii, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/080,900

(22) Filed: Mar. 14, 2005

(30) Foreign Application Priority Data
Mar. 15, 2004 (JP) P.2004-072002

(51) Int. Cl. H04M 1/00

(52) U.S. Cl. 455/67.11; 455/422.1; 455/115.1

(57) ABSTRACT

A network supervisory control system includes at least one wireless network terminal connectable to a wireless network, and a computer which supervises and controls the wireless network terminals, wherein if a first wireless network terminal newly connected to the wireless network establishes a wireless link with an adjacent second wireless network terminal, and transmits an attribute information to the computer, and the second wireless network terminal detects that the wireless link is established, the second wireless network terminal then transmits a network state information indicating a state of the wireless network to the computer, and transmits the attribute information to transmitted from the first wireless network terminal to the computer.

### CROSS-REFERENCE TO RELATED APPLICATIONS

This application is based upon and claims the benefit of priority from the prior Japanese Patent Applications No. 2004-072002, filed on Mar. 15, 2004, the entire contents of which are incorporated herein by reference.

### BACKGROUND OF THE INVENTION

1. Field of the Invention

The present invention relates to a network supervisory control system and a network supervisory control method for supervising the configurations of network terminals and for controlling the network terminals. Particularly, the present invention relates to a network supervisory control system and a network supervisory control method that can cope with a situation where an arbitrary network terminal is frequently installed to and uninstalled from a network system.

2. Description of the Related Art

The following documents relate to a network supervisory control system that supervises the configurations of network terminals and controls the network terminals.

JP-A-2000-099136, JP-A-2000-112595, JP-A-2001-217832, and JP-A-2002-101125 are related to as related art.

FIG. 14 is a block diagram showing the configuration of an example conventional network supervisory control system. In FIG. 14, a computer 1 supervises and controls network terminals; network terminals 2, 3, 4 and 5 function as controllers, actuators or sensors and can be connected to a network; and a network 100 is a multipurpose wired network, such as a LAN (Local Area Network).

The computer 1 is connected to the network 100, and the network terminals 2 to 5 are also connected to the network 100.

FIGS. 15 and 16 are block configuration diagrams showing specific examples for the computer 1 and the network terminals 2 to 5. It should be noted that the network terminal shown in the example in FIG. 16 has a sensor function (a temperature measurement function).

In FIG. 15, a communication unit 6 is, for example, a network interface, for performing communication via the network 100; an operation control unit 7 is, for example, a CPU (Central Processing Unit); and a storage device 8 is, for example, a hard disk, for storing an application program, or a RAM (Random Access Memory), used as a temporary storage unit.

The communication unit 6 is connected to the network 100, and the input and output terminals of the communication unit 6 are connected to the operation control unit 7. The input and output terminals of the operation control unit 7 are connected to the storage device 8.

The operation control unit 7 reads from the storage device 8 the application program that supervises or controls network terminals via the communication unit 6. By executing this application program, the operation control unit 7 can supervise and control the network terminals 2 to 5 that are connected to the network 100.

In FIG. 16, a communication unit 9 is, for example, a network interface, for performing communication via the network 100; an operation control unit 10 is, for example, a CPU; a measurement unit 11 functions as a sensor, for measuring a physical quantity, such as temperature; and a storage device 12 is, for example, a hard disk, for storing an application program, or a RAM, used as a temporary storage unit.

The communication unit 9 is connected to the network 100, and the input and output terminals of the communication unit 9 are connected to the operation control unit 10. The output terminal of the measurement unit 11 is connected to the operation control unit 10, and the input and output terminals of the operation control unit 10 are connected to the storage device 12.

The operation control unit 10 reads from the storage device 12 the application program that permits the measurement unit 11 to measure a physical quantity, such as a temperature, and that outputs the measurement results externally, via the communication unit 9. By executing this program, the operation control unit 10 transmits to the external computer 1, via the network 100, the measurement results obtained by the measurement unit 11.

The processing wherein, in the conventional example in FIG. 14, the computer 1 accesses the network terminals 2 to 5 will now be described while referring to FIG. 17. FIG. 17 is a flowchart for explaining the processing whereby the computer 1 accesses the network terminals 2 to 5.

In FIG. 17, at step S001, the computer 1 (specifically, the operation control unit 7; hereinafter referred to simply as a computer) designates a network terminal to be supervised, i.e., one of the network terminals 2 to 5.

At step S002 in FIG. 17, the computer 1 obtains information, such as a terminal ID, service contents, a serial number and a communication protocol, that is required for accessing the designated network terminal. At step S003 in FIG. 17, the computer 1 employs the obtained information to specify means for accessing a network terminal, and accesses the designated network terminal.

In the conventional example shown in FIG. 14, however, a network terminal to be supervised must be identified in advance, and when the number of network terminals is increased, the management of them becomes complicated.

Further, when another network terminal is added to the network 100, or a network terminal is removed from the network 100, an information change or setup has to be performed.

Especially in a situation where an arbitrary network terminal frequently connects to or disconnects from a wireless network, i.e., a situation where an arbitrary network terminal frequently enters or exits a wireless network area, the performance of information changes or setups can not be caught up with, and the supervision and control of network terminals is difficult.

### SUMMARY OF THE INVENTION

The object of the present invention is to provide a network supervisory control system and a network supervisory control method that can cope with a situation where an arbitrary network terminal is frequently connected to or disconnected from a network system.

The invention provides a network supervisory control system, including: at least one wireless network terminal connectable to a wireless network; and a computer which supervises and controls the wireless network terminal, wherein if a first wireless network terminal newly connected to the wireless network establishes a wireless link with an adjacent second wireless network terminal, and transmits an attribute information to the computer, and the second wireless network terminal detects that the wireless link is established, the second wireless network terminal then transmits a first a network state information indicating a state of the wireless network to the computer, and transmits the attribute information transmitted from the first wireless network terminal to the computer.

The invention also provides a network supervisory control method of a network supervisory control system including at least one wireless network terminal connectable to a wireless network, and a computer which supervises and controls the wireless network terminal, comprising the steps of: a first wireless network terminal is newly connected to the wireless network; the first wireless network terminal establishes a wireless link with an adjacent second wireless network terminal; the first wireless network transmits an attribute information to the computer; the second wireless network terminal detects that the wireless link is established; the second wireless network terminal transmits a first a network state information indicating a state of the wireless network to the computer; and the second wireless network terminal transmits the attribute information transmitted from the first wireless network terminal to the computer.

When the second wireless network terminal detects the wireless link is disconnected, the second wireless network terminal transmits a network state information indicating a state of the wireless network to the computer.

When the attribute information is updated, the first wireless network terminal transmits an updated attribute information to the computer.

The computer includes: a communication unit which communicates via a wired network; a storage unit which stores an application program; and an operation control unit which reads the application program from the storage unit to execute the application program, and supervises and controls the wireless network terminal with using the communication unit.

The wireless network terminal includes: a communication unit which communicates via the wireless network;
a storage unit which stores an application program; a function performance unit; and an operation control unit which reads the application program from the storage unit to execute the application program, and controls the communication unit to transmit an information related to the function performance unit to an external computer.

The function performance unit may be a measurement unit.

The function performance unit may be a control unit.

The function performance unit may be a drive unit.

The computer includes a communication unit connectable to the wireless network, and directly connects to the wireless network.

The computer connects to the wireless network via a gateway that interconnects a wired network and the wireless network.

The network supervisory control system may be applied for a building automation system.

The network supervisory control system may be applied for a plant control system.

The network supervisory control system may be applied for a site patrol system.

The network supervisory control system may be applied for an extensive field supervisory system.

According to the network supervisory control system and the network supervisory control method, the second wireless network terminal detects the establishment or the disconnection of a wireless link with the first adjacent wireless network terminal, and transmits, to the computer, the network state information indicating the existence of a new wireless network terminal or the inexistence of a wireless network terminal. Further, when the attribute information owned by a wireless network terminal is changed, the wireless network terminal transmits an updated attribute information to the computer. Therefore, in a situation where an arbitrary network terminal is frequently connected to or unconnected from the wireless network, the computer can still recognize the configuration for the wireless network and can supervise and control the wireless network terminal.

### BRIEF DESCRIPTION OF THE DRAWINGS

FIG. 1 is a block diagram showing the configuration of a network supervisory control system according to one embodiment of the present invention;

FIG. 2 is a block diagram showing an example configuration for a computer;

FIG. 3 is a block diagram showing an example configuration for a wireless network terminal;

FIG. 4 is a flowchart for explaining the operation of a wireless network terminal that has newly been installed;

FIG. 5 is a diagram for explaining the transmission of information;

FIG. 6 is a flowchart for explaining the operation of a wireless network terminal adjacent to the newly installed wireless network terminal;

FIG. 7 is a diagram for explaining the transmission of information;

FIG. 8 is a diagram for explaining the transmission of information;

FIG. 9 is a flowchart for explaining the operation of a wireless network terminal adjacent to a wireless network terminal that has been removed;

FIG. 10 is a diagram for explaining the transmission of information;

FIG. 11 is a diagram for explaining the transmission of information;

FIG. 12 is a flowchart for explaining the operation of a wireless network terminal performed when attribute information has been changed;

FIG. 13 is a flowchart for explaining the operation of a computer;

FIG. 14 is a block diagram showing the configuration of an example conventional network supervisory control system;

FIG. 15 is a block diagram showing an example configuration for a computer;

FIG. 16 is a block diagram showing an example configuration for a network terminal; and

FIG. 17 is a flowchart for explaining the processing for the accessing of a network terminal by a computer.

### DETAILED DESCRIPTION OF THE PREFERRED EMBODIMENTS

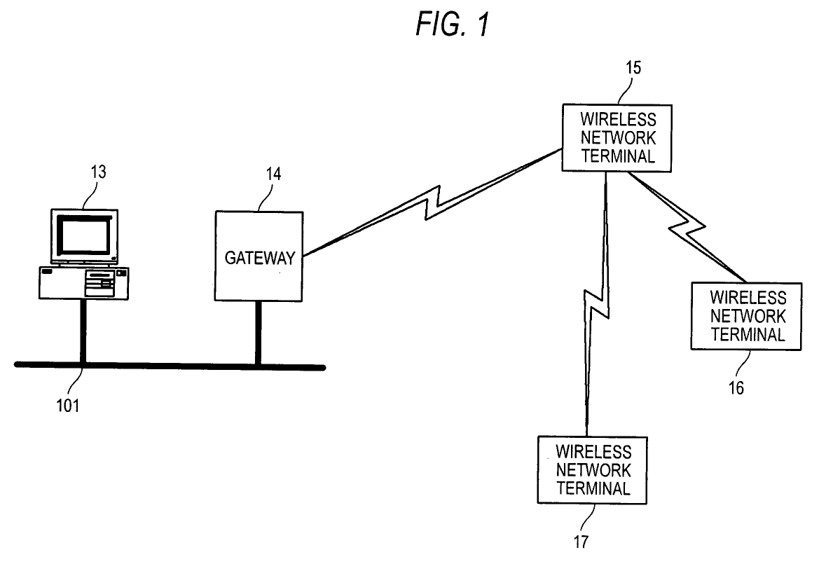

The present invention will now be described in detail while referring to drawings. FIG. 1 is a block diagram showing the configuration of a network supervisory control system according to one embodiment of the invention. In FIG. 1, the network supervisory control system comprises: a computer 13, for supervising and controlling network terminals; a gateway 14, for interconnecting a wired network with a wireless network; wireless network terminals 15, 16 and 17, which function as controllers, actuators or sensors and can be connected to the wireless network; and a multipurpose wired network 101, such as a LAN.

The computer 13 and the gateway 14 are connected to the wired network 101 (hereinafter referred to simply as the network 101), and the wireless network terminal 15 establishes a wireless link with the gateway 14 and with the wireless network terminals 16 and 17 to constitute a wireless network.

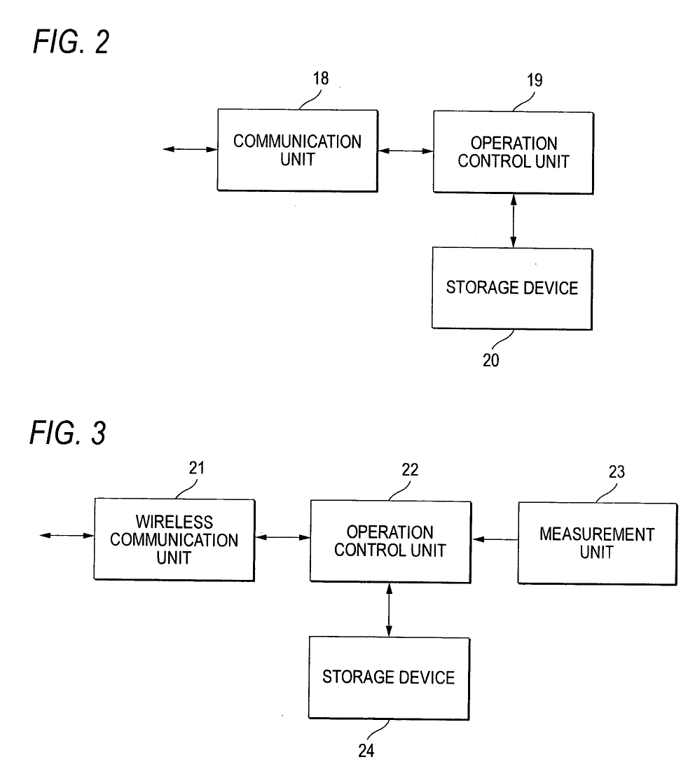

FIGS. 2 and 3 are block diagrams showing specific example configurations for the computer 13 and the wireless network terminals 15 to 17. A wireless network terminal in the example in FIG. 3 has a sensor function (a temperature measurement function).

In FIG. 2, a communication unit 18 is, for example, a network interface for performing communication via the network 101; an operation control unit 19 is, for example, a CPU; and a storage device 20 is, for example, a hard disk, for storing an application program, or a RAM, used as a temporary storage unit.

The communication unit 18 is connected to the network 101, and the input and output terminals of the communication unit 18 are connected to the operation control unit 19. The input and output terminals of the operation control unit 19 are connected to the storage device 20.

The operation control unit 19 reads from the storage device 20 the application program that supervises or controls wireless network terminals via the communication unit 18. By executing this program, the operation control unit 19 can supervise or control the wireless network terminals 15 to 17 via the gateway 14 that is connected to the network 101.

In FIG. 3, a wireless communication unit 21 is, for example, a wireless network interface, for performing communication via a wireless network; an operation control unit 22 is, for example, a CPU; a measurement unit 23 has a sensor function for measuring measure a physical quantity, such as a temperature; and a storage device 24 is, for example, a hard disk, for storing an application program, or a RAM, used as a temporary storage unit.

The wireless communication unit 21 is connected to the wireless network, i.e., establishes a wireless link with each wireless network terminal and with the gateway 14, and the input and output terminals of the wireless communication unit 21 are connected to the operation control unit 22. The output terminal of the measurement unit 23 is connected to the operation control unit 22, and the input and output terminals of the operation control unit 22 are connected to the storage device 24.

The operation control unit 22 reads from the storage device 24 the application program that permits the measurement unit 23 to measure a physical quantity, such as a temperature, and that outputs the measurement results externally via the wireless communication unit 21. By executing this program, the operation control unit 22 transmits the results obtained by the measurement unit 23 to the external computer 13 across the wireless network.

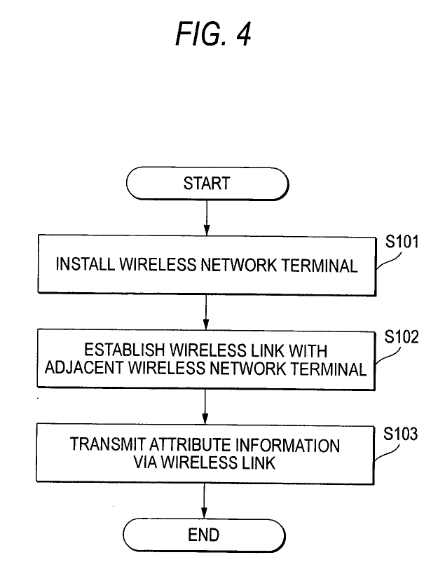

While referring to FIGS. 4 to 13, an explanation will now be given for the operations performed by the wireless network terminals when a new wireless network terminal is installed in the configuration shown in FIG. 1 or when a wireless network terminal is removed.

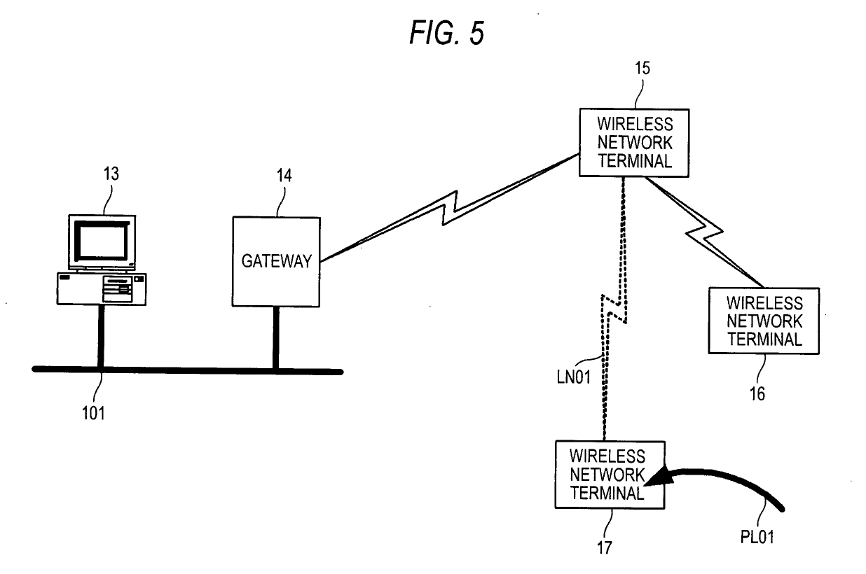

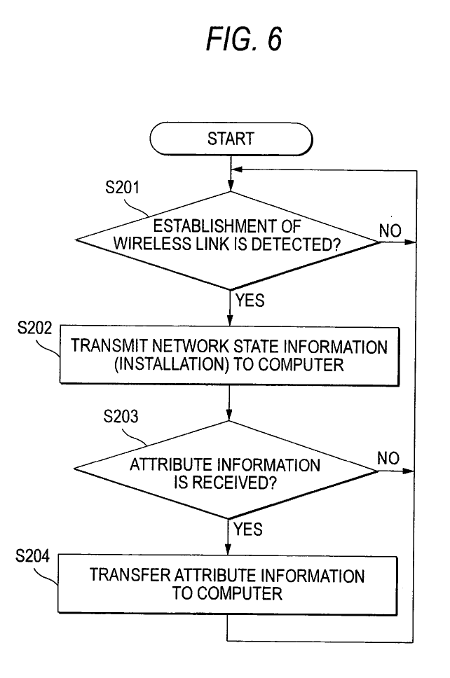

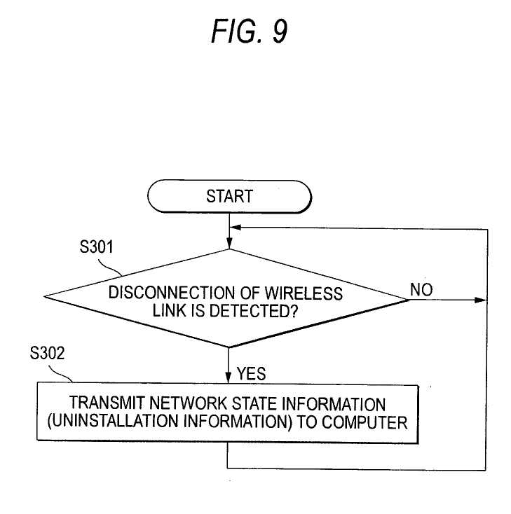

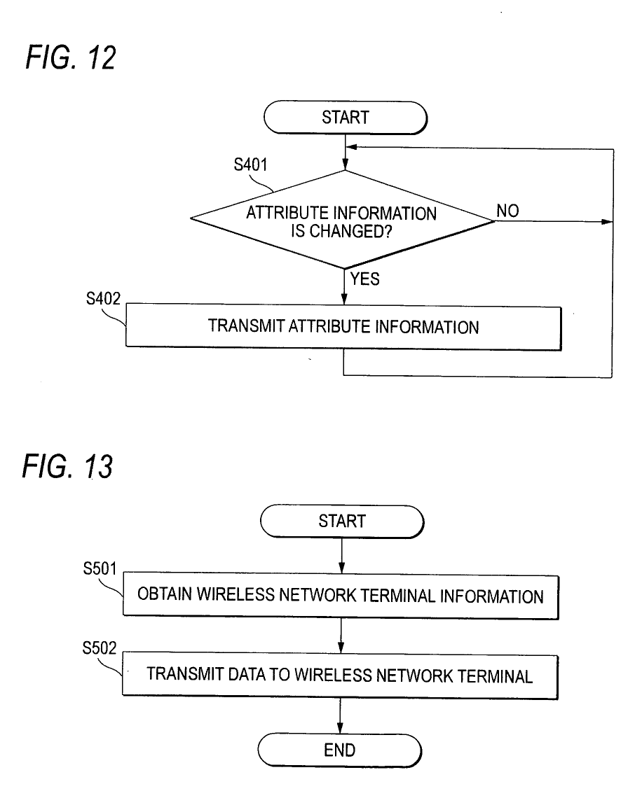

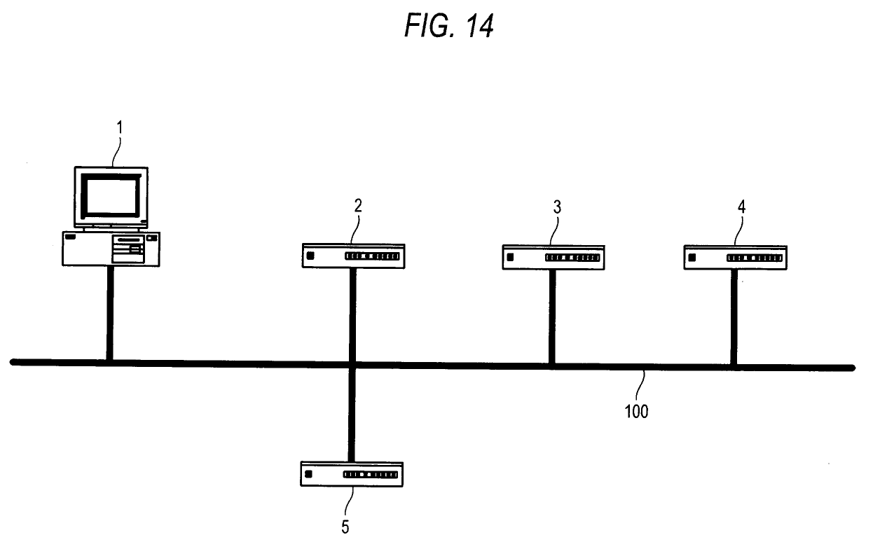

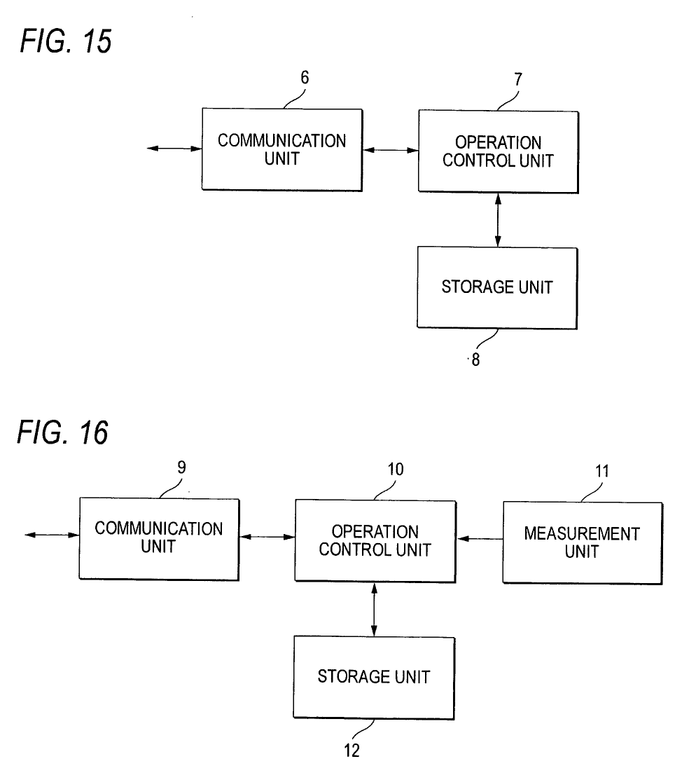

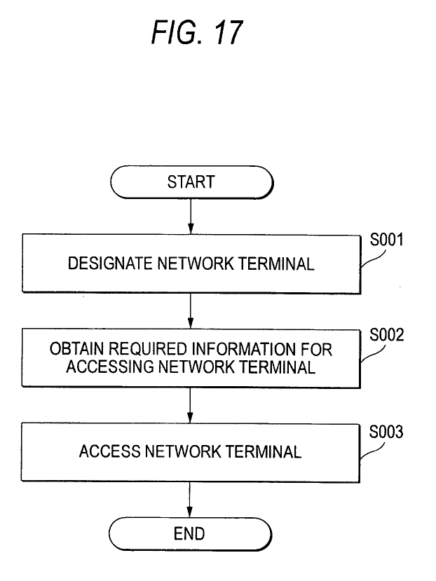

FIG. 4 is a flowchart for explaining the operation of a new wireless network terminal that has been installed. FIGS. 5, 7, 8, 10 and 11 are diagrams for explaining the transmission of information. FIG. 6 is a flowchart for explaining the operation of a wireless network terminal adjacent to the new wireless network terminal. FIG. 9 is a flowchart for explaining the operation of a wireless network terminal adjacent to a wireless network terminal that has been removed from the configuration. FIG. 12 is a flowchart for explaining the operation performed by a wireless network terminal when attribute information is changed. And FIG. 13 is a flowchart for explaining the operation of the computer 13.

In the following explanation, the wireless network terminal 17 in FIG. 1 is designated a wireless network terminal that is to be newly installed or is to be removed from the network system, and the wireless network terminal 15 is designated an adjacent wireless network terminal.

When the wireless network terminal 17 is newly installed at step S101 in FIG. 4, the wireless network terminal 17 establishes a wireless link with an adjacently located wireless network terminal at step S102.

At step S103 in FIG. 4, the new wireless network terminal 17 transmits attribute information, such as an installation location, a service to be provided, a serial number and a network address, to the computer 13 via the wireless link that has been established.

When, for example, the wireless network terminal 17 is installed at a location “PL01” shown in FIG. 5, the wireless network terminal 17 establishes a wireless link “LN01” in FIG. 5 with the adjacent wireless network terminal 15.

At step S201 in FIG. 6, the adjacent wireless network terminal 15 determines whether a wireless link has been established with the new wireless network terminal 17. When the adjacent wireless network terminal 15 determines that a wireless link has been established, at step S202 in FIG. 6, the terminal 15 transmits to the computer 13, via the gateway 14, network state information (installation information) indicating that a new wireless network terminal has been installed.

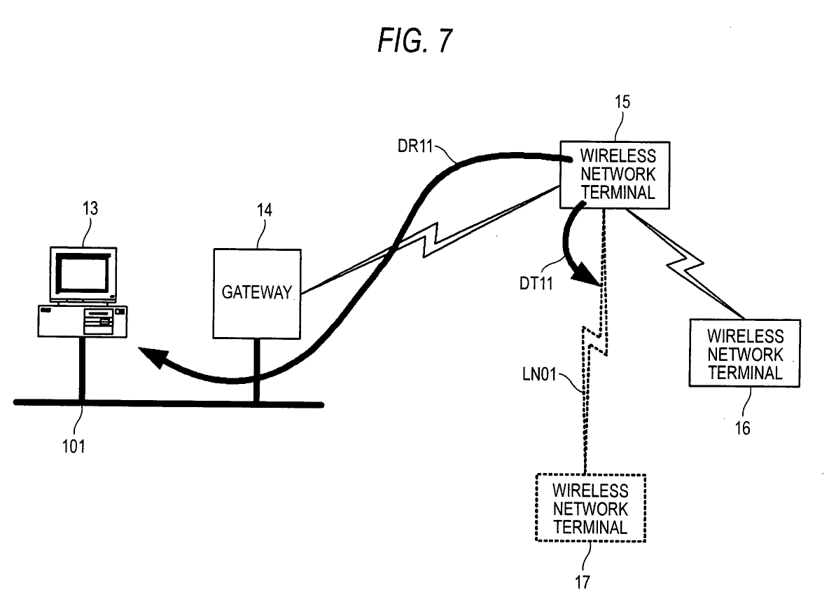

When, for example, the adjacent wireless network terminal 15 detects, as is indicated by “DT11” in FIG. 7, that the wireless link with the new wireless network terminal 17 has been established, as is indicated by “DR11” in FIG. 7, the adjacent wireless network terminal 15 transmits to the computer 13, via the wireless network (the wireless link), the gateway 14 and the network 101, network state information (installation information) indicating that the new wireless network terminal has been installed.

At step S203 in FIG. 6, the adjacent wireless network terminal 15 determines whether attribute information, such as an installation location, a service to be provided, a serial number and a network address, has been received from the new wireless network terminal 17. When the adjacent wireless network terminal 15 determines that the attribute information has been received, this terminal 15 transmits the received attribute information to the computer 13 via the gateway 14 at step S204 in FIG. 6.

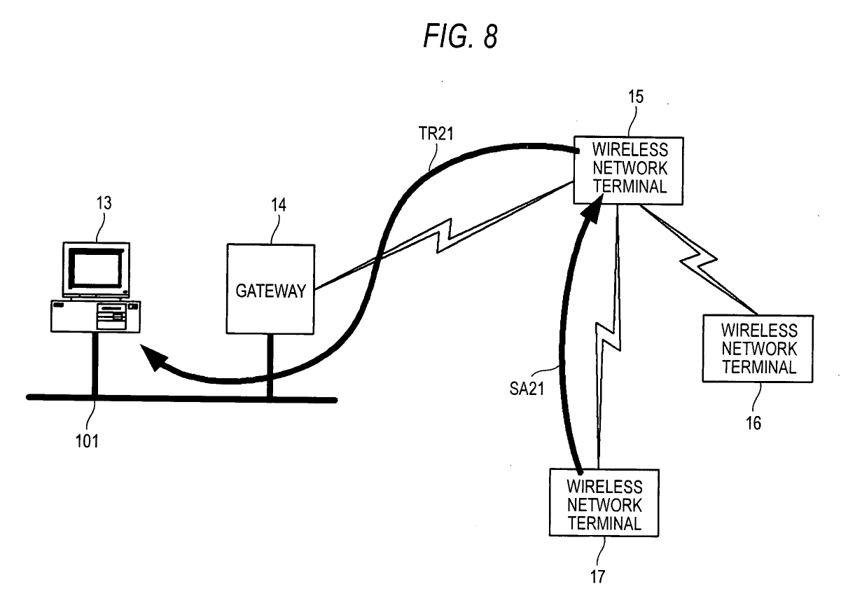

For example, when, as is indicated by “SA21” in FIG. 8, the adjacent wireless network terminal 15 receives attribute information from the new wireless network terminal 17 via the wireless link, the adjacent wireless network terminal 15 transmits the received attribute information to the computer 13 via the wireless network (the wireless link), the gateway 14 and the network 101, as indicated by “TR21” in FIG. 8.

As is described above, the adjacent wireless network terminal detects the establishment of a link with the new wireless network terminal, and transmits to the computer 13 network state information (installation) indicating that the new wireless network terminal has been installed. Therefore, in a situation where an arbitrary network terminal is frequently installed to or uninstalled from the network system, the computer 13 can still recognize the configuration for the wireless network and can supervise and control the wireless network terminal.

At step S301 in FIG. 9, the adjacent wireless network terminal 15 determines whether the wireless network terminal 17 has been uninstalled and whether the wireless link with this terminal 17 has been disconnected. When the disconnection of the wireless link is detected, at step S302 in FIG. 9, the adjacent wireless network terminal 15 transmits to the computer 13, via the gateway 14, network state information (uninstallation information) indicating that the wireless network terminal 17 has been removed.

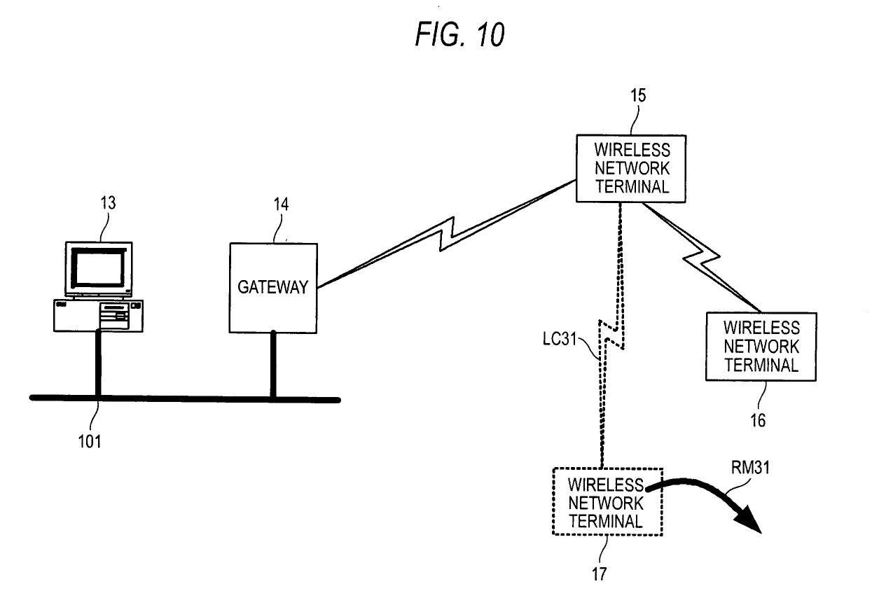

When as indicated by “RM31” in FIG. 10, for example, the wireless network terminal 17 has been removed from the installation location, as is also shown in FIG. 10, a wireless link “LC31” with the adjacent wireless network terminal 15 is disconnected and lost.

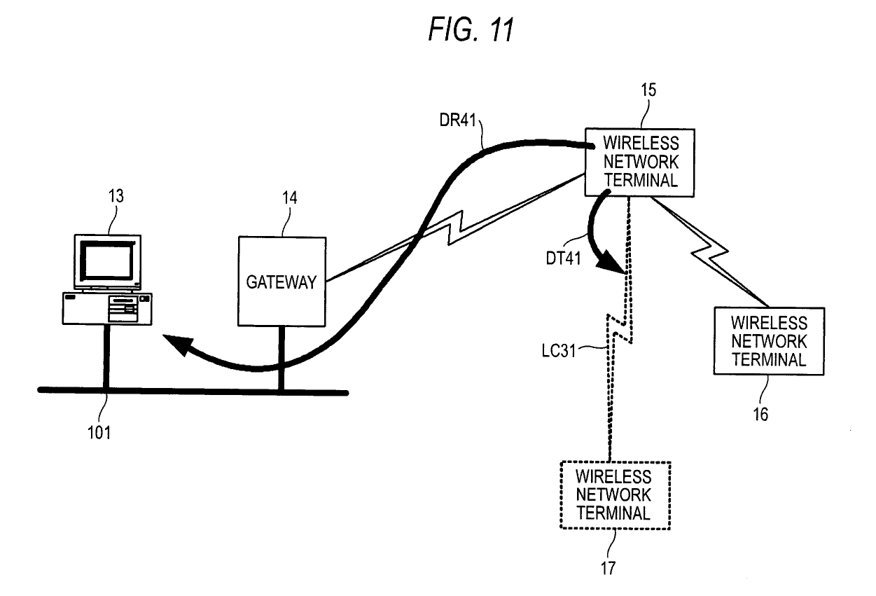

When as indicated by “DT41” in FIG. 11, for example, the adjacent wireless network terminal 15 detects the disconnection of the wireless link “LC31” with the wireless network terminal 17 that has been removed, as is further indicated by “DR41” in FIG. 11, the adjacent wireless network terminal 15 transmits to the computer 13, via the wireless network (the wireless link), the gateway 14 and the network 101, network state information (uninstallation information) indicating that the wireless network terminal 17 has been removed.

As is described above, the adjacent wireless network terminal detects the disconnection of the wireless link with the wireless network terminal that has been removed, and transmits to the computer 13 network state information (uninstallation information) indicating the wireless network terminal has been removed. Therefore, in a situation where an arbitrary network terminal is frequently installed to or uninstalled from the network system, the computer 13 can still recognize the configuration for the wireless network and can supervise and control the wireless net-work-terminal.

At step S401 in FIG. 12, the wireless network terminal 17 determines whether attribute information, such as an installation location and a network address, owned by the terminal 17, has been changed. When the attribute information has been changed, the wireless network terminal 17 transmits updated attribute information to the computer 13 via the gateway 14 at step S402 in FIG. 12.

As is described above, when attribute information, such as an installation location and a network address owned by the wireless network terminal, has been changed, the terminal transmits updated attribute information to the computer 13. Therefore, in a situation where an arbitrary network terminal is frequently installed to or uninstalled from the network system, the computer can still recognize the configuration for the wireless network and can supervise and control the wireless network terminal.

The transfer of data among the terminals will now be described. At step S501 in FIG. 13, the computer 13 obtains information, such as a terminal ID, service contents, a serial number and communication protocol, that is required to access wireless network terminals. At step S502 in FIG. 13, the computer 13 employs the obtained information to access the wireless network terminals and transmits data.

For example, the transfer of data by the computer 13 to the wireless network terminal 17 is performed via the wireless network terminal 15.

Since the computer 13 obtains information, such as the terminal ID of a specific wireless network terminal, service contents, a serial number and communication protocol, and employs the obtained information to access the wireless network terminal and to transmit data, the transfer of data by the computer 13 to the specific wireless network terminal is enabled.

In the embodiment shown in FIG. 1, the computer 13 is connected to the wired network 101; however, a communication unit, such as a wireless network interface, may be provided for the computer 13 so that it can connect directly to a wireless network without having to use the gateway 14.

In the example in FIG. 3, the measurement unit 23 is provided for the wireless network terminal. However, the function provided for the wireless network terminal is not limited to the measurement unit, and a function performance unit, such as a unit that functions as a controller or a drive unit that functions as an actuator, may be provided.

When the function performance unit is a measurement unit, a control unit or a drive unit, information related to such a unit corresponds to a measurement value, a setup value, or actuator positional information.

Furthermore, for the embodiment shown in FIG. 1, the transmission of all the information to the computer 13 is performed via the wireless network terminal 15 because of the configuration in FIG. 1 (the wireless link situation). However, the route for the transfer of data is not limited to this one, and transfers may be performed via an arbitrary number of wireless network terminals, or it may be transmitted directly to the computer 13.

Further, for the embodiment in FIG. 1, the transmission destination for network state information and attribute information is the computer 13. However, the destination may be an adjacent wireless network terminal, and the wireless network terminals may relay data that is to be transmitted to the computer 13.

In addition, for the embodiment in FIG. 1, the data transfer method employed provides for the transfer of data from the computer 13 to a specific wireless network terminal. However, the transfer of data among wireless network terminals, or the transfer of data from a specific wireless network terminal to the computer 13 may be employed.

In the embodiment in FIG. 1, an explanation has been given for the network supervisory control system that supervises the configuration of the network wireless terminals and controls the wireless network terminal. However, the present invention can also be applied for the following systems.
(1) Building automation systems
(2) Plant control systems
(3) Site patrol systems
(4) Extensive field supervisory systems

(1) For the building automation systems, wireless network terminals are employed, and a server is provided that manages the configuration for the wireless network by concentrating a variety of information at the server. With this arrangement, information concerning the configuration of a large number of wireless network terminals installed in a building can be dynamically managed, so that a system having superior usability and extendibility can be constructed. Furthermore, management costs can be reduced.

(2) For the plant control systems, when a wireless network is constructed using wireless network terminals, operation costs and construction costs can be reduced. Further, when an event notification function for furnishing notification of a detected event is provided for each wireless network terminal, the configuration of wireless network terminals in a plant can easily be controlled.

(3) For the site patrol systems, when a portable terminal, such as a PDA (Personal Digital Assistant) or a PHS (Personal Handyphone System), is employed to perform maintenance/diagnosis of site terminals, a wireless network terminal having a different function need only be temporarily installed at the site. Thus, the temporary use of the different function can be enabled.

(4) For the extensive field supervisory systems, wireless network terminals that collect information, such as measurement values, images and sounds, need only be arranged in a field that is to be supervised, so that a situation where an arbitrary network terminal is frequently @@installed to or uninstalled from the system can be coped with.

1. A network supervisory control system, comprising:
at least one wireless network terminal connectable to a wireless network; and
a computer which supervises and controls the wireless network terminal,
wherein if a first wireless network terminal newly connected to the wireless network establishes a wireless link with an adjacent second wireless network terminal, and transmits an attribute information to the computer, and the second wireless network terminal detects that the wireless link is established, the second wireless network terminal then transmits a first a network state information indicating a state of the wireless network to the computer, and transmits the attribute information transmitted from the first wireless network terminal to the computer.

2. The network supervisory control system according to claim 1,
wherein when the second wireless network terminal detects the wireless link is disconnected, the second wireless network terminal transmits a network state information indicating a state of the wireless network to the computer.

3. The network supervisory control system according to claim 1,
wherein, when the attribute information is updated, the first wireless network terminal transmits an updated attribute information to the computer.

4. The network supervisory control system according to claim 1,
wherein the computer includes:
a communication unit which communicates via a wired network;
a storage unit which stores an application program; and
an operation control unit which reads the application program from the storage unit to execute the application program, and supervises and controls the wireless network terminal with using the communication unit.

5. The network supervisory control system according to claim 1,
wherein the wireless network terminal includes:
a communication unit which communicates via the wireless network;
a storage unit which stores an application program;
a function performance unit; and
an operation control unit which reads the application program from the storage unit to execute the application program, and controls the communication unit to transmit an information related to the function performance unit to an external computer.

6. The network supervisory control system according to claim 5,
wherein the function performance unit is a measurement unit.

7. The network supervisory control system according to claim 5,
wherein the function performance unit is a control unit.

8. The network supervisory control system according to claim 5,
wherein the function performance unit is a drive unit.

9. The network supervisory control system according to claim 1,
wherein the computer includes a communication unit connectable to the wireless network, and directly connects to the wireless network.

10. The network supervisory control system according to claim 1,
wherein the computer connects to the wireless network via a gateway that interconnects a wired network and the wireless network.

11. The network supervisory control system according to claim 1, being applied for a building automation system.

12. The network supervisory control system according to claim 1, being applied for a plant control system.

13. The network supervisory control system according to claim 1, being applied for a site patrol system.

14. The network supervisory control system according to claim 1, being applied for an extensive field supervisory system.

15. A network supervisory control method of a network supervisory control system comprising at least one wireless network terminal connectable to a wireless network, and a computer which supervises and controls the wireless network terminal, comprising the steps of:
a first wireless network terminal is newly connected to the wireless network;
the first wireless network terminal establishes a wireless link with an adjacent second wireless network terminal;
the first wireless network transmits an attribute information to the computer;
the second wireless network terminal detects that the wireless link is established;
the second wireless network terminal transmits a first a network state information indicating a state of the wireless network to the computer; and
the second wireless network terminal transmits the attribute information transmitted from the first wireless network terminal to the computer.
